(19) United States
(12) Patent Application Publication
(10) Pub. No.: US 2011/0181245 A1
(43) Pub. Date: Jul. 28, 2011

(54) UNITIZED CHARGING AND DISCHARGING BATTERY MANAGEMENT SYSTEM AND PROGRAMMABLE BATTERY MANAGEMENT MODULE THEREOF

(75) Inventors: Chin-Long Wey, Hsinchu (TW); Chun-Ming Huang, Hsinchu (TW); Shih-Lun Chen, Hsinchu (TW); Chi-Sheng Lin, Hsinchu (TW); Ting-Hsu Chien, Hsinchu (TW); Jiann-Jenn Wang, Hsinchu (TW)

(73) Assignee: National Chip Implementation Center National Applied Research Laboratories., Hsinchu City (TW)

(21) Appl. No.: 12/728,288

(22) Filed: Mar. 22, 2010

(30) Foreign Application Priority Data
Jan. 22, 2010 (TW) 099101698

(51) Int. Cl. H02J 7/00

(52) U.S. Cl. 320/118

(57) ABSTRACT

The present invention discloses a unitized charging and discharging battery management system and a programmable battery management module thereof The unitized charging and discharging battery management system includes a smart battery module and a programmable battery management module, which has a universal loop and a control unit. The smart battery module has at least two smart batteries which are electrically connected by a plurality of switches and circuits of the universal loop to form a charging/discharging loop in series/parallel. The control unit monitors the charging and discharging status of the smart batteries to turn on or off the switches accordingly, so as to manage the smart batteries, thereby enhancing the overall power efficacy of the smart battery module. Besides, the service life of the smart battery module is also prolonged due to the simultaneous charging and discharging capability.

### BACKGROUND OF THE INVENTION

1. Technical Field

The present invention relates to a unitized charging and discharging battery management system and a programmable battery management module thereof. More particularly, the unitized charging and discharging battery management system and the programmable battery management module of the present invention are applicable to the power management of a smart battery module.

2. Description of Related Art

Rechargeable batteries are now widely used in many portable electronic products and consumer devices, such as laptops, mobile phones, digital still cameras and digital video cameras. Moreover, with the increasing environmental awareness, rechargeable batteries are also being applied to solar batteries, hybrid vehicles, electric cars and so on. In order to improve the conventional rechargeable batteries by indicating the residual power therein, a smart battery was developed, one which implements a residual power monitoring device, a temperature sensor and other sensors to detect the variation of the charge-discharge cycle taking place in the smart battery, so as to prevent the smart battery from undercharge or overcharge.

For example, an average lithium-ion battery has a voltage typically ranging between 3.3V and 3.6V so that a battery set composed of plural lithium-ion batteries connected in series provides a voltage ranging between 30V and 45V. When applied to a hybrid vehicle requiring a 450V DC supply, more than ten such lithium-ion battery sets have to be used in combination. In order to efficiently exploit such a huge array of lithium battery sets, it is necessary to equip the lithium battery sets with smart power managing function for enhancing their performance and stability in charging/discharging. This ensures that a load or an electronic product powered by the lithium battery sets runs with stable operation and without interference while increasing fault tolerance, enhancing charging efficiency and prolonging battery life.

Indeed, for many high-voltage applications, a battery set composed of a plurality of batteries connected in series is a practical solution. However, these serially connected batteries are likely to have unequal respective voltages and power levels during their charging or discharging stage. Moreover, such non-balance can significantly reduce the overall charging efficiency of the battery set and shorten the service life of each of the batteries therein, or may even lead to dangerous explosion.

FIG. 1 depicts a conventional battery set 10. As shown therein, the battery set 10 is composed of a plurality of batteries 11 connected in series, and employs a plurality of switches 12 to ensure a charging balance where each said battery 11 is fully charged. However, there are currently no designs that provide discharging bypass. If any one of the serially connected batteries 11 has deteriorated, failed, or used up its power while discharging, this problematic battery 11 will be shut down by its over-discharge protection, and the whole battery set 10 will be in turn stopped from discharging.

Thus, the total discharge energy of the battery set is subject to the battery or batteries with lower capacitance. This hinders the power stored in the battery or batteries with higher capacitance from being used. Furthermore, the problematic battery or batteries, without the discharging bypass design, stand the risk of being reversely charged and be potentially dangerous. Moreover, the conventional battery set always retains a constant output voltage that can not be adjusted, causing the operation of the battery set to be undesirably inflexible.

### BRIEF SUMMARY OF THE INVENTION

The present invention provides a unitized charging and discharging battery management system and a programmable battery management module thereof, wherein a universal loop is implemented to change the connection between smart batteries and a charging/discharging module, so as to charge and discharge the smart batteries simultaneously, thereby prolonging the service life of the smart battery module.

The present invention also provides a unitized charging and discharging battery management system and a programmable battery management module thereof, wherein a control unit is implemented to perform power management for multiple smart batteries connected in series, thereby improving charging/discharging efficiency and prolonging the service life of the batteries.

The present invention also provides a unitized charging and discharging battery management system and a programmable battery management module thereof, whereby various output voltages are provided by using the smart battery module more flexibly.

The present invention also provides a unitized charging and discharging battery management system and a programmable battery management module thereof, wherein the programmable battery management module enhances the utilization rate of the discharge energy, thereby improving the overall power efficacy of the smart battery module.

In order to achieve the above effects, the present invention provides a unitized charging and discharging battery management system, which comprises a smart battery module having at least two smart batteries, and a programmable battery management module having: a universal loop electrically connected to the smart batteries and having a plurality of switches and circuits that form a configurable charging/discharging loop in series/parallel, and a control unit being a programmable controller for turning on/off the switches.

In order to achieve the above effects, the present invention further provides a programmable battery management module for managing a smart battery module that has a plurality of smart batteries. The programmable battery management module comprises a universal loop, electrically connected with the smart battery module and having a plurality of switches and circuits that form a configurable charging/discharging loop in series/parallel, and a control unit being a programmable controller for turning on/off the switches.

By implementing the present invention, at least the following progressive effects can be achieved:

1. By using the unitized charging and discharging battery management system, the control unit controls the discharging capacity of the smart batteries in the smart battery module, so as to provide different output voltages.

2. The control unit serves to monitor the status of the smart batteries and control the connection between the universal loop and the smart batteries, thereby simultaneously charging and discharging the smart batteries so as to improve the charging/discharging efficiency and prolong the service life of the smart batteries.

3. By using the programmable battery management module to monitor and manage the smart battery module, the utilization rate of the discharge energy can be improved, thereby in turn enhancing the overall power efficacy of the smart battery module.

4. When applied to an electrical vehicle system equipped with a charging device, the programmable battery management module can use its simultaneous charging and discharging ability to improve the battery life of the electrical vehicle system.

### BRIEF DESCRIPTION OF THE SEVERAL VIEWS OF THE DRAWINGS

The invention as well as a preferred mode of use and advantages thereof will be best understood by referring to the following detailed description of the illustrative embodiment in conjunction with the accompanying drawings, wherein:

FIG. 1 shows a charging/discharging system of a conventional battery set;

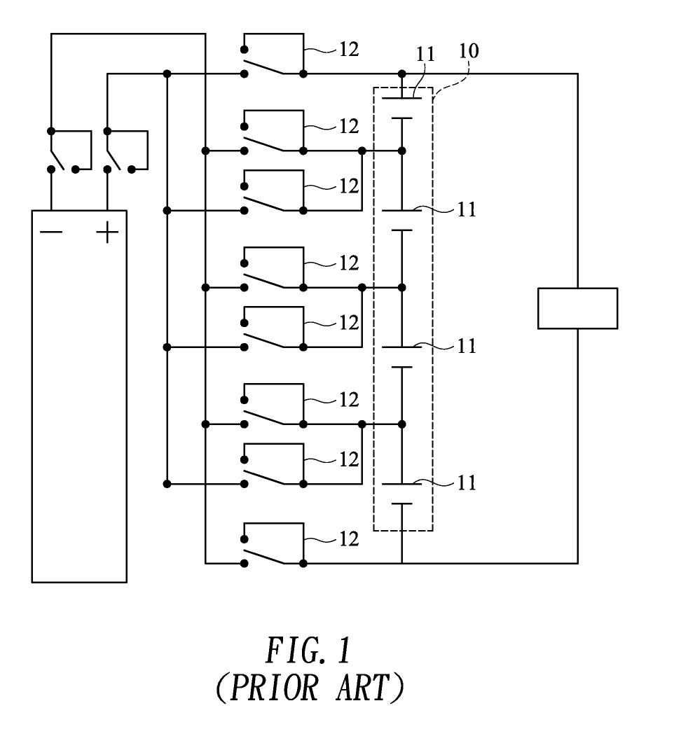

FIG. 2 is a block diagram of a unitized charging and discharging battery management system according to the present invention;

FIG. 3 is a circuit diagram of the unitized charging and discharging battery management system according to the present invention;

FIG. 4, basing on FIG. 3, shows the discharging status of the unitized charging and discharging battery management system in one aspect;

FIG. 5, basing on FIG. 3, shows the discharging status of the unitized charging and discharging battery management system in another aspect;

FIG. 6, basing on FIG. 3, shows the charging status of the unitized charging and discharging battery management system in one aspect;

FIG. 7, basing on FIG. 3, shows the charging status of the unitized charging and discharging battery management system in another aspect;

FIG. 8, basing on FIG. 3, shows the simultaneous charging and discharging status of the unitized charging and discharging battery management system in one aspect;

FIG. 9, basing on FIG. 3, shows the simultaneous charging and discharging status of the unitized charging and discharging battery management system in another aspect; and

FIG. 10 shows multiple said unitized charging and discharging battery management systems of the present invention connected in parallel.

### DETAILED DESCRIPTION OF THE INVENTION

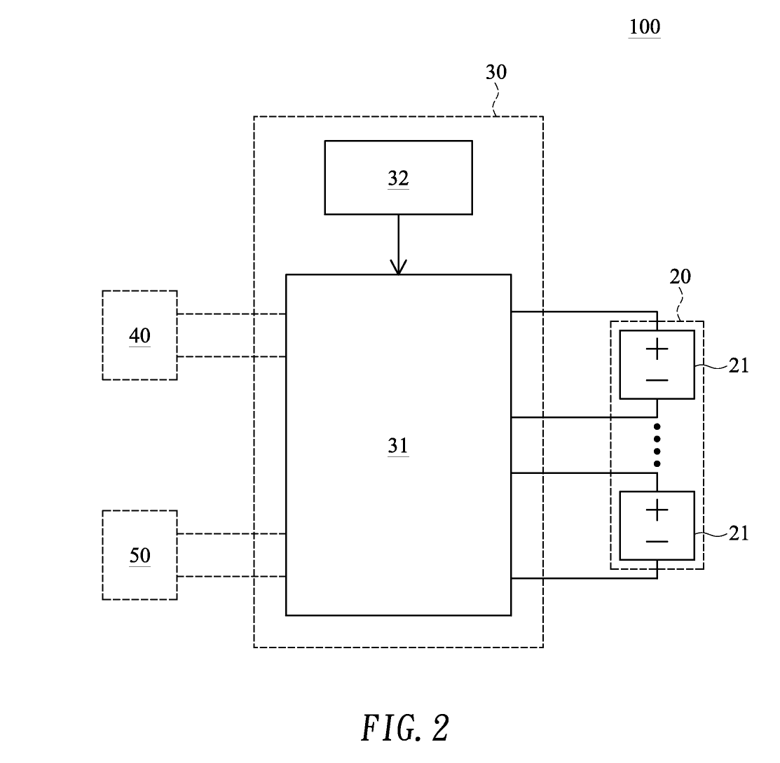

Referring to FIG. 2, a preferred embodiment of the present invention is a unitized charging and discharging battery management system 100, which includes: a smart battery module 20 and a programmable battery management module 30.

The smart battery module 20 has at least two smart batteries 21, which may be dry batteries, lithium batteries, Ni—H batteries, lead acid batteries or solar cells. The smart batteries 21 are connected in series to form the smart battery module 20. Each of the smart batteries 21 is equipped with a residual power monitoring device, a temperature sensor and other sensors to detect the variation of the charge-discharge cycle taking place in the smart battery 21, so as to prevent the smart battery 21 from undercharge or overcharge.

The programmable battery management module 30 has a universal loop 31 and a control unit 32.

The universal loop 31 serves to electrically connect the smart batteries 21 to a charging module 40 and a discharging module 50 while the control unit 32 controls how the universal loop 31 is connected to the smart batteries 21, so as to connect the smart batteries 21 in series or parallel before the universal loop 31 electrically connects the smart batteries 21 with the charging module 40 and/or the discharging module 50. Alternatively, the control unit 32 may cause one part of said smart batteries 21 to be connected in series while the other part of said smart batteries 21 are connected in parallel and then are electrically connected to the charging module 40 and/or the discharging module 50.

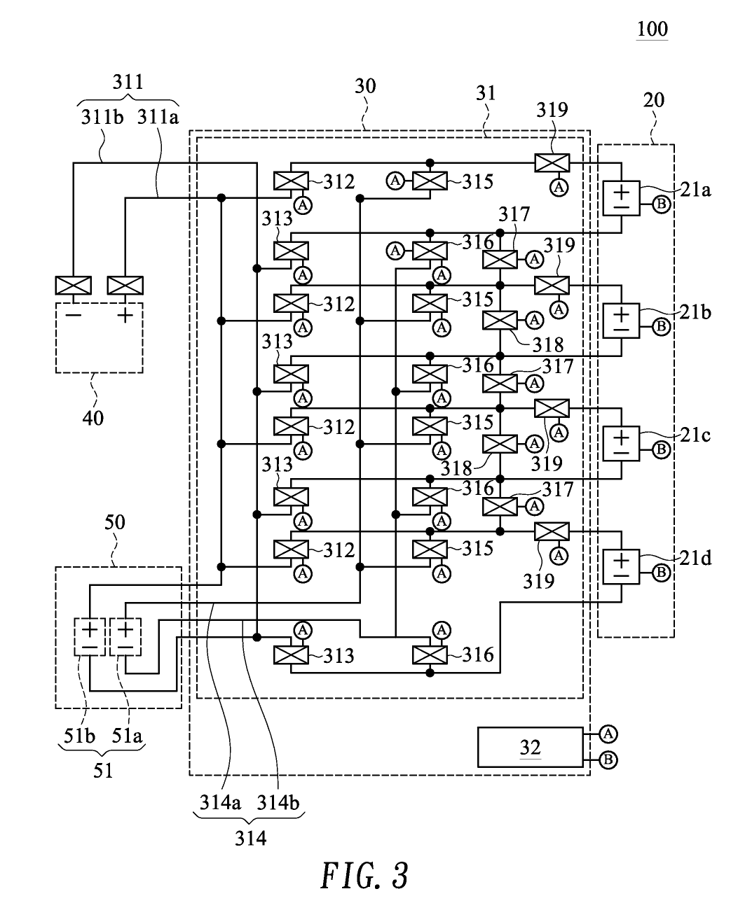

As shown in FIG. 3, the universal loop 31 contains a plurality of switches and circuits. By changing the way the switches and the circuits connect and by using the control unit 32 to turn on or off the switches, the universal loop 31 is enabled to form a configurable charging/discharging loop in series/parallel.

The electrical connection of the switches and circuits in the universal loop 31 with the charging module 40, the discharging module 50 and the smart battery module 20 will be discussed below.

Referring to FIG. 3, the universal loop 31 has a first DC bus 311, a plurality of first and second switches 312, 313, a second DC bus 314 and a plurality of third and fourth switches 315, 316.

The first DC bus 311 has a first anode wire 311a and a first cathode wire 311b, which are electrically connected to an anode end and a cathode end of the charging module 40.

The first and second switches 312, 313 belong to the switches. Each said first switch 312 is connected in series between the first anode wire 311 a and an anode end of a corresponding said smart battery 21a, 21b, 21c, or 21d while each said second switch 313 is connected in series between the first cathode wire 311b and a cathode end of a corresponding said smart battery 21a, 21b, 21c or 21d.

The second DC bus 314 has a second anode wire 314a and a second cathode wire 314b, which are electrically connected with an anode end and a cathode end of the discharging module 50. The discharging module 50 may include at least one load 51a. When there are more than two said loads 51a, 51b in the discharging module 50, the second anode wire 314a and the second cathode wire 314b may be electrically connected with an anode end and a cathode end of one said load 51a while another said load 51b may have its anode end electrically connected with the first anode wire 311a and have its cathode end electrically connected with the first cathode wire 311b.

The third and fourth switches 315, 316 belong to the switches. Each said third switch 315 is connected in series between the second anode wire 314a and an anode end of a corresponding said smart battery 21a, 21b, 21c or 21d while each said fourth switch 316 is connected in series between the second cathode wire 314b and a cathode end of a corresponding said smart battery 21a, 21b, 21c or 21d.

The universal loop 31 further comprises fifth switches 317, sixth switches 318 and seventh switches 319, all belonging to the switches. Each said fifth switch 317 is connected in series between a cathode end of a corresponding said smart battery 21a, 21b or 21c and an anode end of another said smart battery 21b, 21c or 21d. Each said sixth switch 318 is connected in parallel between the anode end and the cathode end of a said smart battery 21b or 21c. In the meantime, each said seventh switch 319 is connected in series between an anode end of a corresponding said smart battery 21a, 21b, 21c or 21d and a said first switch 312.

The control unit 32 may be a programmable controller and signally connected with each residual power monitoring devices in the smart batteries 21a, 21b, 21c and 21d for monitoring the residual power of each said smart battery 21a, 21b, 21c and 21d, and in turn controlling the on/off status of the corresponding switches, so as to achieve power management for the smart batteries 21a, 21b, 21c and 21d.

More particularly, when any of the smart batteries 21a, 21b, 21c and 21d has its power almost used up during discharge, the control unit 32 controls the corresponding switch to isolate this smart battery 21a, 21b, 21c or 21d, and timely adds one or more said smart battery 21a, 21b, 21c or 21d as spare batteries according to the power requirements of the discharging module 50. Consequently, the discharging capacity of the smart battery module 20 can be maintained in a desired and usable range while allowing the rest smart batteries 21a, 21b, 21c or 21d to smoothly discharge without interruption. Besides, the isolated smart battery 21a, 21b, 21c or 21d may be at this time charged by the charging module 40 to be later reconnected and utilized.

Herein, several aspects of charging circuits, discharging circuits, and charging-discharging circuits formed by the universal loop 31, the smart battery module 20, the charging module 40 and the discharging module 50 in series, in parallel or in series-parallel are discussed for illustration.

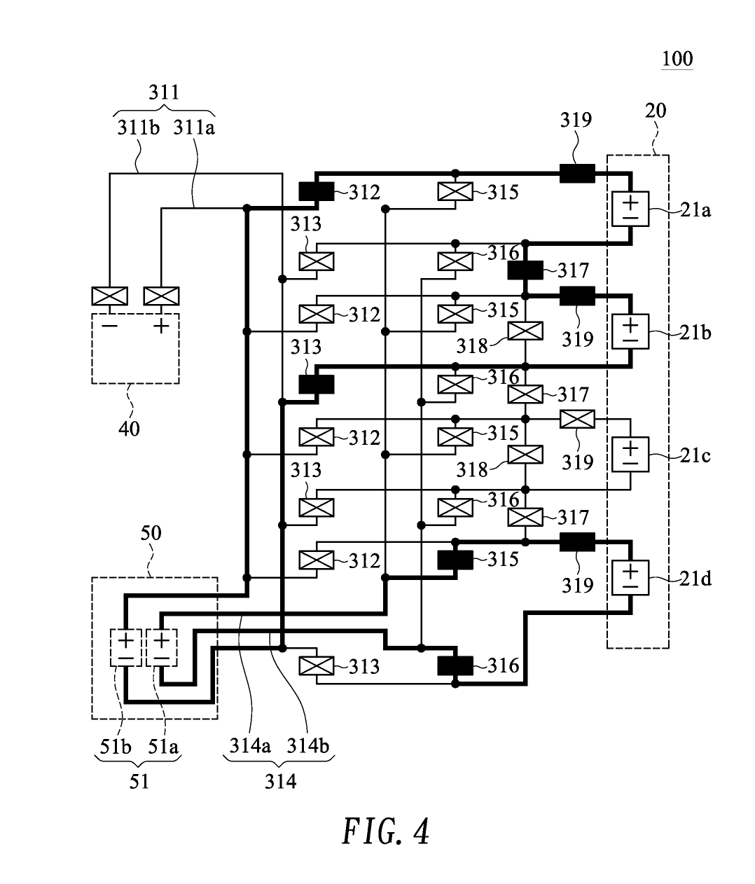

As shown in FIG. 4, the smart battery module 20 is in its discharging status. In the discharging module 50, there are two said loads 51a, 51b. One said load 51a only requires power from one said smart battery 21d and the other load 51b needs power supplied by two said smart batteries 21a and 21b. The control unit 32 thus turns the switches on or off to make one said smart battery 21d electrically connected to the load 51a and make two other said smart batteries 21a and 21b connected in series mutually before making the serially connected smart batteries 21a and 21b electrically connected with the other load 51b. In addition, assuming that one said smart battery 21c has to be isolated, the control unit 32 thus turns off the switch associated with this smart battery 21c, so as to isolate the smart battery 21c from the discharging loop.

Furthermore, by turning on the third switch 315, the seventh switch 319 and the fourth switch 316 and by using the second anode wire 314a and the second cathode wire 314b to electrically connect the load 51a, the load 51a is allowed to form a discharging loop in series with the smart battery 21d. Moreover, by turning on the fifth switch 317 and the seventh switches 319, two adjacent said smart batteries 21a and 21b are connected in series, and by turning on the corresponding said first switch 312 and second switch 313, the smart batteries 21a and 21b connected in series form a discharging loop with the other load 51b.

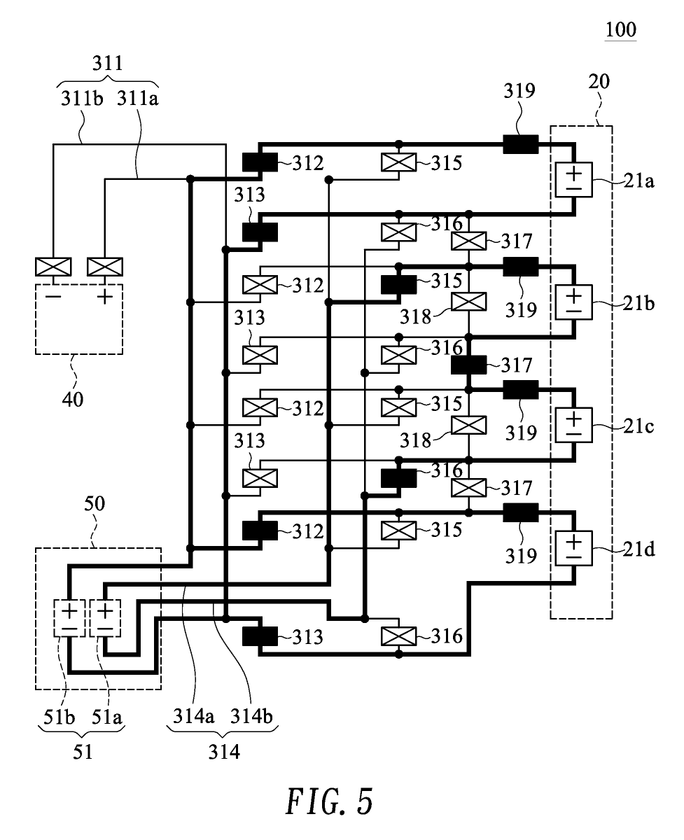

Referring to FIG. 5, it shows the discharging status of the smart battery module 20 in another aspect. Similarly, the discharging module 50 has two said loads 51a, 51b. One said load 51a requires power from two said smart batteries 21b and 21c connected in series. The other load 51b needs power from two said smart batteries 21a and 21d connected in parallel.

Therefore, the control unit 32 controls the on or off switches to turn on the corresponding fifth switches 317 and seventh switches 319 so as to make two adjacent smart batteries 21b and 21c connected in series. In the meantime, by turning on the third switch 315, the seventh switch 319, and the fourth switch 316, and by making the second anode wire 314a and the second cathode wire 314b electrically connected to the load 51a, the load 51a with the smart batteries 21b and 21c connected in series jointly form a discharging loop in series. Additionally, the control unit 32 may simultaneously turn on two other sets of said switches, namely the first switches 312, the second switches 313, and the seventh switches 319, so as to make the corresponding smart batteries 21a and 21d connected in parallel and form a discharging loop in parallel with the other load 51b.

Thus, by virtue of the programmable battery management module 30, various output discharging voltages can be provided so as to use the smart battery module 20 with improved flexibility and meet the need of loads 51a and 51b.

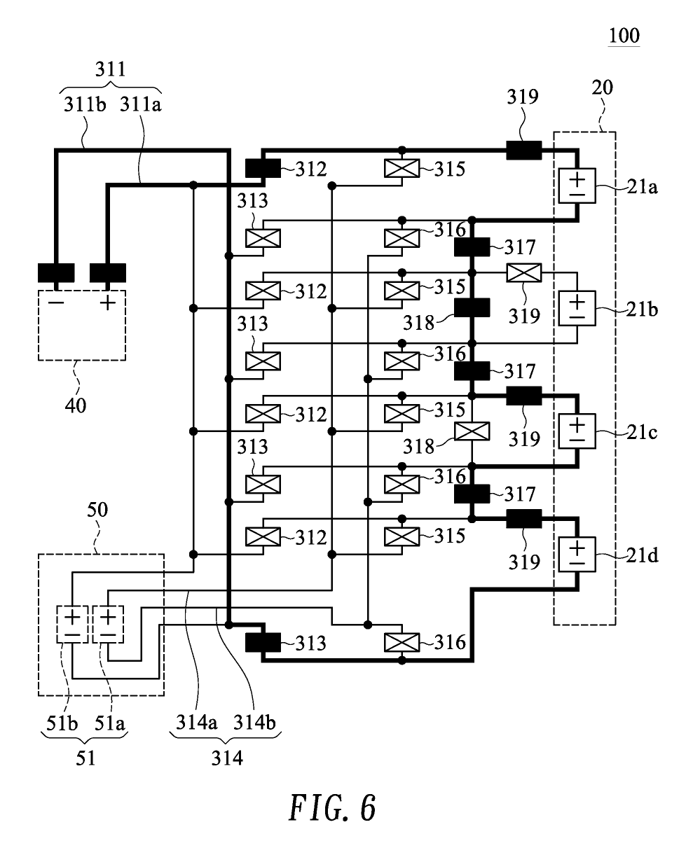

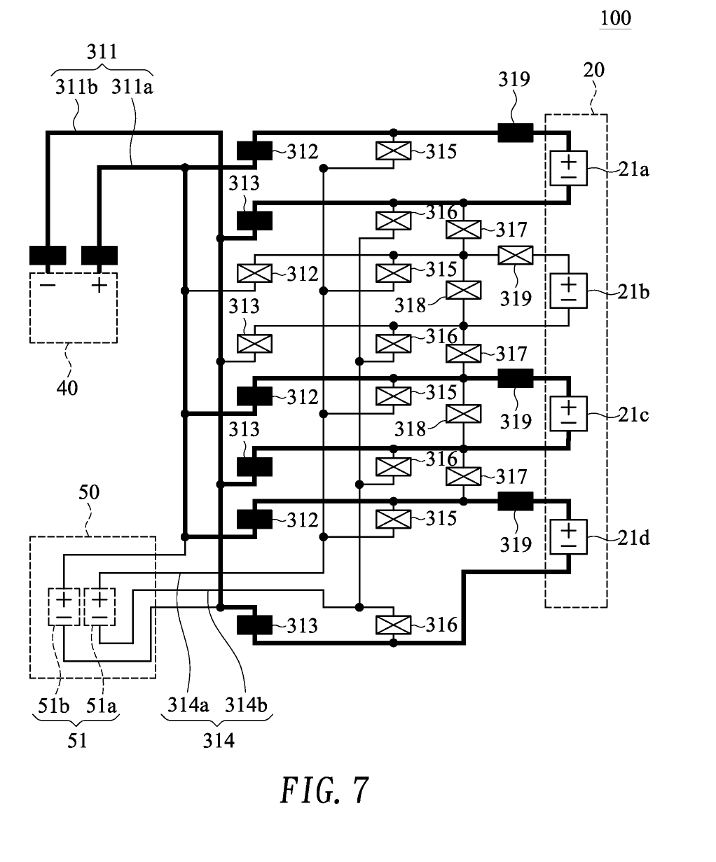

FIG. 6 and FIG. 7 show the smart battery module 20 being charged. In the charging status, the smart batteries 21a, 21c, and 21d to be charged may be connected in series mutually and form a charging loop in series with the charging module 40 (as shown in FIG. 6). Alternatively, the smart batteries 21a, 21c, and 21d may be connected in parallel and form a charging loop in parallel with the charging module 40 (as shown in FIG. 7).

For example, if the control unit 32 detects the smart battery 21b as having adequate power and does not need to be charged, it can use the connection of the switches and wires in the universal loop 31 to separate the smart battery 21b that does not need charge from the charging loop.

Referring to FIG. 6, as for the smart battery module 20, by turning on the fifth switches 317 and seventh switches 319, the adjacent smart batteries 21a, 21b, 21c, and 21d can be connected in series mutually. However, when it is desired to separate a certain said smart battery 21b, the sixth switch 318 connected in parallel with the smart battery 21b is turned on and the seventh switch 319 connected in series with its anode end is turned off, so that the smart battery 21b is isolated. In addition, the corresponding first switch 312 and second switch 313 can be turned on, so that the smart batteries 21a, 21c, and 21d connected in series mutually form a charging loop in series with the charging module 40.

Referring to FIG. 7, if it is desired to have the smart batteries 21a, 21c and 21d connected in parallel mutually and form charging circuits in parallel with the charging module 40 respectively, the control unit 32 may turn on the first switch 312, second switch 313, and seventh switch 319 connected in series with the smart batteries 21a, 21c, and 21d, so as to make the smart batteries 21a, 21c, and 21d electrically connected with the charging module 40 respectively and connected in parallel mutually.

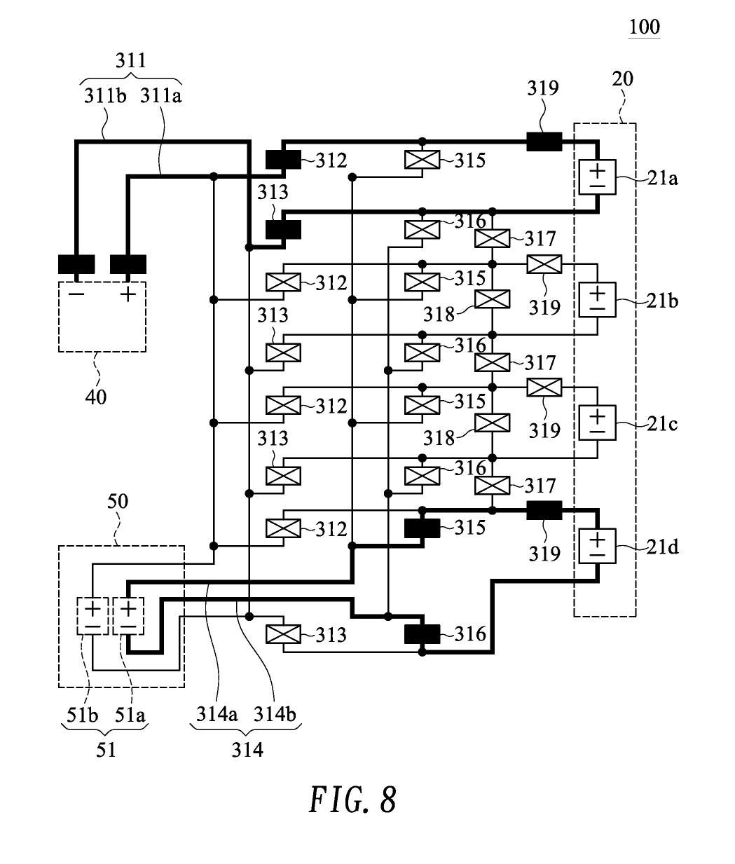

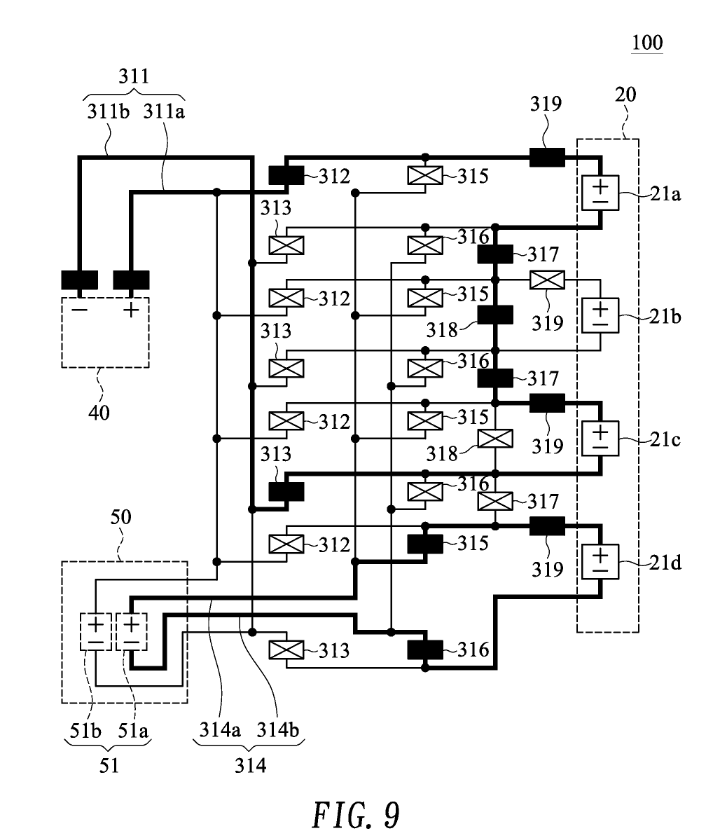

FIG. 8 and FIG. 9 show the smart batteries 21a and 21d in the smart battery module 20 charging and discharging simultaneously.

Referring to FIG. 8, assuming that the residual power of the smart battery 21a in the smart battery module 20 is too low, the control unit 32 will break off the switches that are electrically connected with the smart battery 21a and the discharging module 50, so as to make the smart battery 21a electrically connected with the charging module 40 through the first switch 312, second switch 313, and seventh switch 319 for being charged. Simultaneously, another said smart battery 21 d may also be electrically connected with one said load 51a through the third switch 315, seventh switch 319 and fourth switch 316 for discharging.

Referring to FIG. 9, if the control unit 32 detects that a said smart battery 21b is broken, the control unit 32 turns on the sixth switch 318 connected in parallel with the smart battery 21b, and turns off the seventh switch 319 connected in series with its anode end, so as to isolate the smart battery 21b. Thus, it can prevent the smart battery 21b from affecting the overall charging and discharging status of the smart battery module 20.

Therefore, the control unit 32 can monitor the power level of all the smart batteries 21a, 21b, 21c, and 21d in a real-time manner, and selectively turn on or off the switches, so as to make the smart batteries 21a, 21b, 21c, and 21d charge or discharge timely. More preferably, it can charge and discharge the smart batteries 21a, 21b, 21c, and 21d at the same time. Thereby, not only is the service life of the smart battery module 20 prolonged, but also the overall power efficacy of the smart battery module 20 is improved while the battery life of the smart battery module 20 is also lengthened.

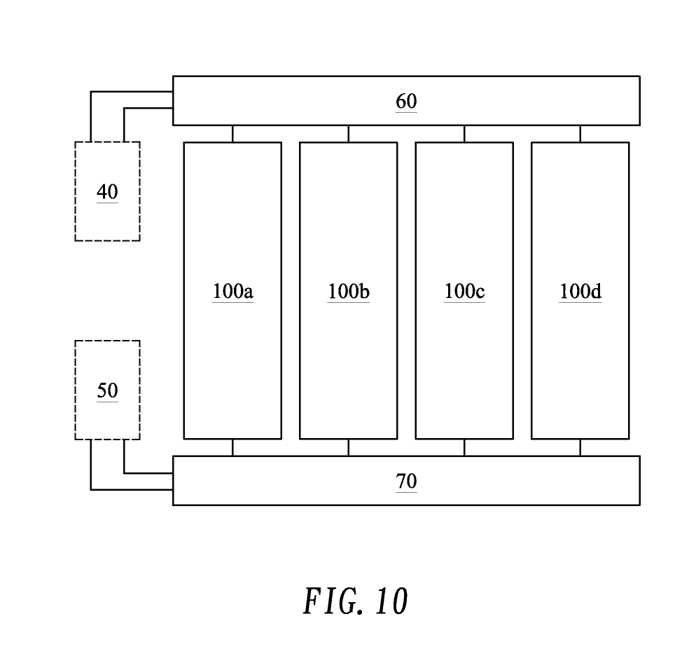

As shown in FIG. 10, it is possible to connect multiple said unitized charging and discharging battery management systems 100a, 100b, 100c, 100d in parallel. Then, a first power management module 60 and a second power management module 70 are used to respectively manage the electrical connection between each of the unitized charging and discharging battery management systems 100a, 100b, 100c, 100d with the charging module 40 and the discharging module 50. Thereby, the charging and/or discharging status of each of the unitized charging and discharging battery management systems 100a, 100b, 100c, 100d is dynamically controlled.

The embodiment described above is intended only to demonstrate the technical concept and features of the present invention so as to enable a person skilled in the art to understand and implement the contents disclosed herein. It is understood that the disclosed embodiment is not to limit the scope of the present invention. Therefore, all equivalent changes or modifications based on the concept of the present invention should be encompassed by the appended claims.

What is claimed is:

1. A unitized charging and discharging battery management system, comprising:
a smart battery module having at least two smart batteries; and
a programmable battery management module having:
a universal loop electrically connected to the smart batteries and having a plurality of switches and circuits that form a configurable charging/discharging loop in series/parallel; and
a control unit being a programmable controller for turning on/off the switches.

2. The charging and discharging battery management system of claim 1, wherein the universal loop has:
a first DC bus having a first anode wire and a first cathode wire;
a plurality of first and second switches belonging to the switches, wherein each of the first switches is connected in series between the first anode wire and an anode end of one said smart battery while each of the second switches is connected in series between the first cathode wire and a cathode end of one said smart battery;
a second DC bus having a second anode wire and a second cathode wire; and
a plurality of third and fourth switches belonging to the switches, wherein each of the third switches is connected in series between the second anode wire and an anode end of one said smart battery while each of the fourth switches is connected in series between the second cathode wire and a cathode end of one said smart battery.

3. The charging and discharging battery management system of claim 2, wherein the universal loop further includes a fifth switch belonging to the switches and connected in series between a cathode end of one said smart battery and an anode end of another said smart battery.

4. The charging and discharging battery management system of claim 2, wherein the universal loop further includes at least one sixth switch belonging to the switches and connected in parallel between an anode end and a cathode end of one said smart battery.

5. The charging and discharging battery management system of claim 2, wherein the universal loop further includes at least one seventh switch belonging to the switches and connected in series between an anode end of one said smart battery and one said first switch.

6. A programmable battery management module for managing a smart battery module that has a plurality of smart batteries, the programmable battery management module comprising:
a universal loop electrically connected to the smart battery module, and having a plurality of switches and circuits that form a configurable charging/discharging loop in series/parallel; and
a control unit being a programmable controller for turning on/off the switches.

7. The programmable battery management module of claim 6, wherein the universal loop has:
a first DC bus having a first anode wire and a first cathode wire;
a plurality of first and second switches belonging to the switches, wherein each of the first switches is connected in series between the first anode wire and an anode end of one said smart battery while each of the second switches is connected in series between the first cathode wire and a cathode end of one said smart battery;
a second DC bus having a second anode wire and a second cathode wire; and
a plurality of third and fourth switches belonging to the switches, wherein each of the third switches is connected in series between the second anode wire and an anode end of one said smart battery while each of the fourth switches is connected in series between the second cathode wire and a cathode end of one said smart battery.

8. The programmable battery management module of claim 6, wherein the universal loop further includes a fifth switch belonging to the switches and connected in series between a cathode end of one said smart battery and an anode end of another said smart battery.

9. The programmable battery management module of claim 6, wherein the universal loop further includes at least one sixth switch belonging to the switches and connected in parallel between an anode end and a cathode end of one said smart battery.

10. The programmable battery management module of claim 6, wherein the universal loop further includes at least one seventh switch belonging to the switches and connected in series between an anode end of one said smart battery and one said first switch.
